(19) United States
(12) Patent Application Publication
(10) Pub. No.: US 2011/0150321 A1
(43) Pub. Date: Jun. 23, 2011

(54) METHOD AND APPARATUS FOR EDITING DEPTH IMAGE

(75) Inventors: Won-Sik CHEONG, Daejeon (KR); Gun BANG, Daejeon (KR); Gi Mun UM, Daejeon (KR); Hong-Chang SHIN, Seoul (KR); Namho HUR, Daejeon (KR); Soo In LEE, Daejeon (KR); Jin Woong KIM, Daejeon (KR)

(73) Assignee: Electronics and Telecommunications Research Institute, Daejeon (KR)

(21) Appl. No.: 12/890,872

(22) Filed: Sep. 27, 2010

(30) Foreign Application Priority Data
Dec. 21, 2009 (KR) 10-2009-0128116

(51) Int. Cl. G06K 9/00

(52) U.S. Cl. 382/154

(57) ABSTRACT

Provided is a method of editing a depth image, comprising: receiving a selection on a depth image frame to be edited and a color image corresponding to the depth image frame; receiving a selection on an interest object in the color image; extracting boundary information of the interest object; and correcting a depth value of the depth image frame using the boundary information of the interest object.

### CROSS-REFERENCE TO RELATED APPLICATION

This application claims the benefit of Korean Patent Application No. 10-2009-0128116, filed on Dec. 21, 2009, in the Korean Intellectual Property Office, the disclosure of which is incorporated herein by reference.

### BACKGROUND

1. Field of the Invention

The present invention relates to a method and apparatus for editing a depth image, and more particularly, to a method and apparatus for editing a depth image that may more accurately correct a depth value of a depth image in a three-dimensional (3D) image including a color image and the depth image.

2. Description of the Related Art

A scheme of more accurately editing an acquired depth image may use technologies published in a Moving Picture Experts Group (MPEG). Schemes published in the MPEG basically assume that a depth image well made through a manual operation exists.

One of the published schemes may find a motionless background area using a motion estimation scheme, and then prevent a depth value from significantly changing over time, using a depth value of a previous frame with the assumption that depth values of the depth image over time barely change in the found motionless background, and thereby enhancing the quality of the depth image.

Another scheme of the published schemes may correct a depth value of a current frame by applying a motion estimation scheme to a manually acquired depth image.

The above schemes may automatically perform a depth image correction with respect to continuous frames excluding a first frame of the depth image. Accordingly, to edit the depth image using the above schemes, the first frame of the depth image needs to be well made.

A manual operation scheme with respect to the first frame of the depth image may include still image editing software such as Adobe Photoshop, Corel Paint Shop Pro, and the like.

The above schemes may correct a depth value of a depth image while simultaneously viewing a color image and a depth image, or may correct the depth value of the depth image while overlappingly viewing the color image and the depth image by setting the color image as a background image.

However, results of using the above schemes may vary depending on skills of a user editing the depth image. To increase accuracy, a great amount of time and efforts may be required for an editor.

### SUMMARY

An aspect of the present invention provides a method and apparatus for editing a depth image that may minimize a work amount of a human used for editing a depth image, and also increase an accuracy of the depth image.

According to an aspect of the present invention, there is provided a method of editing a depth image, including: receiving a selection on a depth image frame to be edited and a color image corresponding to the depth image frame; receiving a selection on an interest object in the color image; extracting boundary information of the interest object; and correcting a depth value of the depth image frame using the boundary information of the interest object.

According to another aspect of the present invention, there is provided a method of editing a depth image, including: receiving a selection on a depth image frame to be edited and a color image corresponding to the depth image frame; extracting object boundary information of a current frame corresponding to the depth image frame using a frame of a previous viewpoint or an adjacent viewpoint of the color image; and correcting a depth value of the depth image frame using the object boundary information of the current frame.

According to still another aspect of the present invention, there is provided an apparatus for editing a depth image, including: an input unit to receive a selection on a depth image frame to be edited, a color image corresponding to the depth image frame, and an interest object in the color image; an extraction unit to extract boundary information of the interest object; and an edition unit to correct a depth value of the depth image frame using the boundary information of the interest object.

According to yet another aspect of the present invention, there is provided an apparatus for editing a depth image, including: an input unit to receive a selection on a depth image frame to be edited and a color image corresponding to the depth image frame; an extraction unit to extract object boundary information of a current frame corresponding to the depth image frame using a frame of a previous viewpoint or an adjacent viewpoint of the color image; and an edition unit to correct a depth value of the depth image frame using the object boundary information of the current frame.

### EFFECT

According to embodiments of the present invention, it is possible to minimize a work amount of a human used for editing a depth image.

Also, according to embodiments of the present invention, it is possible to acquire a three-dimensional (3D) content having a relatively great 3D effect.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a video-plus-depth image according to a related art;

FIG. 2 illustrates an example of receiving a color image and a depth image with respect to three viewpoints to output nine viewpoints according to the related art;

FIG. 3 is a block diagram illustrating an apparatus for editing a depth image according to an embodiment of the present invention;

FIG. 4 is a flowchart illustrating a method of editing a depth image according to an embodiment of the present invention;

FIG. 5 illustrates a three-dimensional (3D) image including a color image and a depth image, and an image of indicating, in the depth image, boundary information of an object extracted from the color image according to an embodiment of the present invention;

FIG. 6 is a flowchart illustrating a method of editing a depth image according to an embodiment of the present invention;

FIG. 7 is a flowchart illustrating a method of editing a depth image according to an embodiment of the present invention; and

FIG. 8 is a flowchart illustrating a method of editing a depth image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Together with an ultra definition television (UDTV) service, a broadcasting service using a three-dimensional (3D) image has been gaining an attention as a next-generation broadcasting service followed by a high definition television (HDTV) service. With developments of related technologies such as the release of commercial auto-stereoscopic display with the high quality, a three-dimensional television (3DTV) service is predicted to be provided within a few years to enable a user to view a 3D image at home.

A 3DTV technology has been developing from a stereoscopic technology of providing the 3D image by providing a single left image and a single right image to a multi-view image technology of providing an image of a viewpoint suitable for a viewer's viewing location using images of multiple viewpoints and an auto-stereoscopic display.

In particular, a technology where a video-plus-depth technology and a depth-image-based rendering (DIBR) technology are combined has many advantages compared to other technologies and thus is regarded to be most suitable for a 3D service.

The video-plus-depth technology corresponds to one of technologies for servicing multi-view images to a viewer and thus, may provide the 3D service using an image corresponding to each viewpoint and a depth image of a corresponding viewpoint.

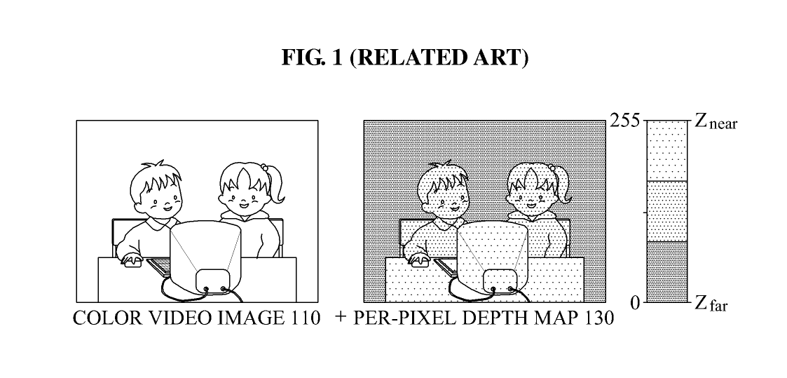

FIG. 1 illustrates a video-plus-depth image according to a related art.

Referring to FIG. 1, the video-plus-depth image may be acquired by adding a depth image 130, that is, a per-pixel depth map to a color video image 110. When using the video-plus-depth image, it is possible to maintain a compatibility with a general two-dimensional (2D) display. The depth image 130 may be compressed at a relatively low bitrate compared to a general image and thus, may enhance a transmission efficiency.

Also, an intermediate viewpoint image may be generated from an image of a photographed viewpoint and thus, it is possible to transmit images corresponding to a number of viewpoints suitable for a limited bandwidth. Specifically, it is possible to generate images corresponding to a number of viewpoints required by a viewer.

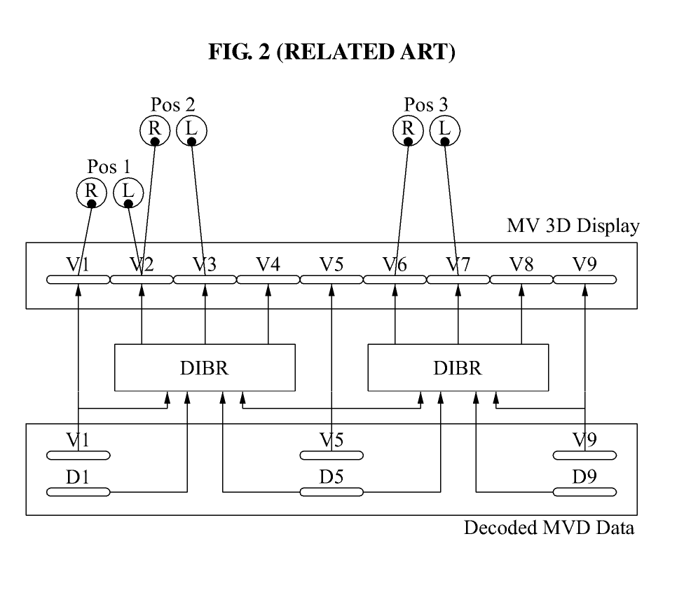

To solve an occlusion issue that is one of disadvantages of the video-plus-depth technology, it is possible to use a DIBR technology together as shown in FIG. 2.

FIG. 2 illustrates an example of receiving a color image and a depth image with respect to three viewpoints to output nine viewpoints according to the related art.

Referring to FIG. 2, when nine viewpoints are used for an auto-stereoscopic display and thereby nine images are transmitted, it may need a great amount of transmission bandwidth.

Accordingly, by transmitting three images V1, V5, and V9 together with depth images D1, D5, and D9 corresponding thereto, and by transmitting nine images to a user through an intermediate viewpoint image generation using the above images, it is possible to enhance a transmission efficiency. The DIBR technology may be employed to generate an intermediate image.

As described above, a technology where the video-plus-depth technology and the DIBR technology are combined may have various advantages compared to other technologies, and may satisfy items desired to be considered in providing a 3DTV service to each home.

Since the above technology assumes that a depth of a given image is accurately given based on a depth image, the accuracy of the depth image may become a key factor to determine a satisfaction of the 3D image service.

According to an embodiment of the present invention, there is provided a method of editing a depth image, which is important in giving a 3D effect. By appropriately correcting a depth value of a depth image based on an object existing in a color image and object information associated with a depth image corresponding to the object, it is possible to obtain an accurate depth value and to provide an enhanced quality 3D image based on the depth value.

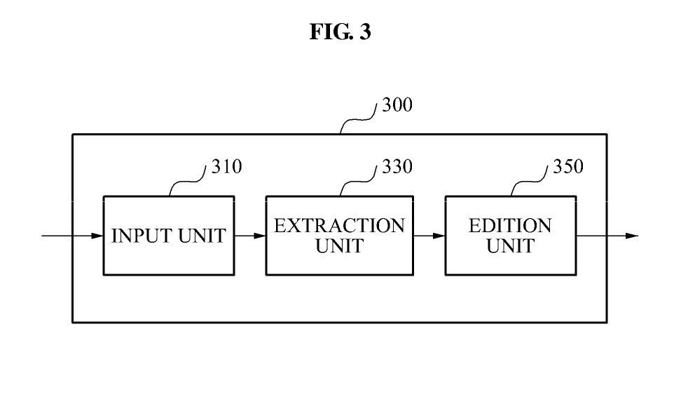

FIG. 3 is a block diagram illustrating an apparatus 300 for editing a depth image according to an embodiment of the present invention.

Referring to FIG. 3, the depth image editing apparatus 300 may include an input unit 310, an extraction unit 330, and an edition unit 350.

The input unit 310 may receive, from a user, a selection on a depth image frame to be edited and a color image corresponding to the depth image frame, and a selection on an interest object in the color image. Here, the color image may include a motion picture and a still image.

The extraction unit 330 may extract boundary information of the interest object that is selected by the user via the input unit 310.

The input unit 310 may receive, from the user, a resection on the interest object. The extraction unit 330 may re-extract boundary information of the reselected interest object.

According to an embodiment of the present invention, a method and apparatus for editing a depth image may find an object boundary, that is, an object outline in a color image having accurate information compared to a depth image with respect to each object existing in a screen, and may apply a depth image to the object boundary, and may apply the found object boundary, that is, outline to the depth image and thereby correct a depth value of the depth image.

Accordingly, a major edition target may include a major interest object of an image selected by an editor or a user, and objects around the major interest object.

Here, the term “major object” may not indicate only an object having a physical meaning in a color image, that is, having a complete shape in the color image. The major object may include an area having the same depth image characteristic such as an area where a discontinuity of depth values does not exist, and the like. This is because an edition target is not the color image but the depth image.

In this instance, at least one or at least two interest objects may be included in a single depth image.

The edition unit 350 may correct the depth value of the depth image frame based on the boundary information of the interest object extracted by the extraction unit 330.

The edition unit 350 may further include a boundary information extraction unit (not shown) to extract, from the depth image frame, boundary information of an area corresponding to the interest object. Also, the edition unit 350 may correct the depth value of the depth image frame by comparing the boundary information of the area corresponding to the interest object extracted by the boundary information extraction unit with the boundary information of the interest object extracted by the extraction unit 330.

The edition unit 350 may correct the depth value of the depth image frame using an extrapolation scheme.

As described above, according to an embodiment of the present invention, a depth image editing apparatus may edit a depth value of a depth image using only a depth image frame that is currently desired to be edited and a color image corresponding to the depth image frame. The edition method may be referred to as a within-frame depth image editing method that is a method of editing a depth image within a frame.

Also, the depth image editing apparatus may edit a depth value of a depth image of a current frame based on information associated with a frame of a previous viewpoint or an adjacent viewpoint of a color image.

The above edition method is referred to an inter-frame depth image editing method that is a method of editing a depth image between frames. A depth image editing apparatus using the inter-frame depth image will be described according to another embodiment of the present invention

The depth image editing apparatus according to another embodiment of the present invention may also include the input unit 310, the extraction unit 330, and the edition unit 350.

The input unit 310 may receive a selection on a depth image frame to be edited and a color image corresponding to the depth image frame. The input unit 310 may also receive, from a user, a selection on an interest object in the color image.

The extraction unit 330 may extract object boundary information of a current color image frame corresponding to the depth image frame using a frame of a previous viewpoint or an adjacent viewpoint of the color image. Also, the extraction unit 330 may re-extract boundary information of the interest object reselected via the input unit 310.

The extraction unit 330 may extract object boundary information of the current color image frame by tracing the frame of the previous viewpoint or the adjacent viewpoint of the color image according to a motion estimation scheme and the like.

Here, the color image frame may include a motion picture and a still image.

The edition unit 350 may correct the depth value of the depth image frame using object boundary information of a current frame.

The edition unit 350 may determine an object boundary area to be corrected based on the object boundary information of the current frame, and correct the depth value by applying an extrapolation scheme to the determined object boundary area and thereby editing the depth image.

Here, the extrapolation scheme corresponds to a scheme of tracing a function value with respect to a variable value outside a predetermined variable range when function values with respect to variable values within the predetermined variable range are known. Therefore, the extrapolation scheme may calculate a function value with respect to points outside the range of given basic points.

Also, the edition unit 350 may determine an object boundary area to be corrected based on the object boundary information of the current frame, and may correct the depth value of the depth image corresponding to the determined object boundary area using a depth value of a corresponding location in the frame of the previous viewpoint or the adjacent viewpoint of the color image.

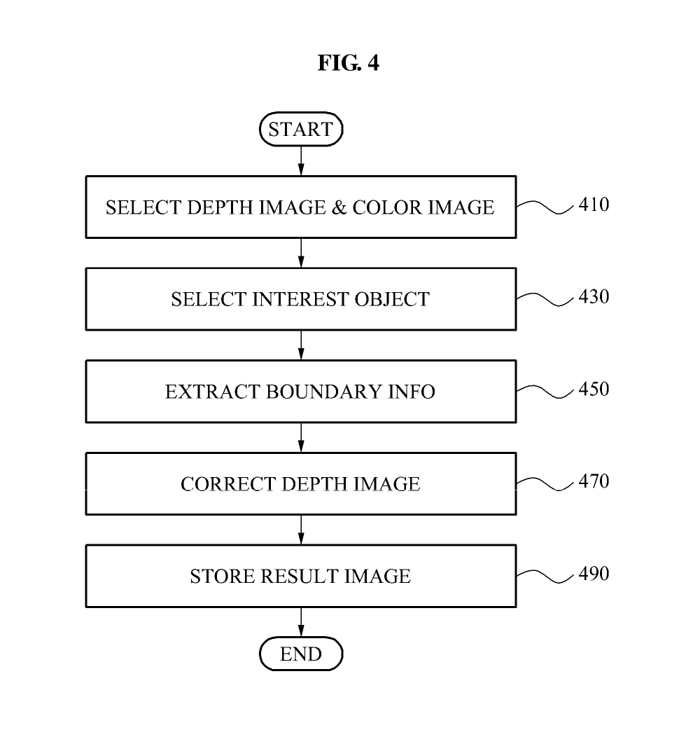

According to an embodiment of the present invention, a method of editing a depth image may use an inter-frame depth image editing method of editing a depth value of a depth image using a depth image frame currently desired to be edited and a color image corresponding to the depth image frame. It will be further described with reference to FIG. 4 through FIG. 6.

FIG. 4 is a flowchart illustrating a method of editing a depth image according to an embodiment of the present invention.

Referring to FIG. 4, the depth image editing method may include operation 410 of receiving a selection on a depth image and a color image, operation 430 of receiving a selection on an interest object, operation 450 of extracting boundary information, operation 470 of correcting the depth image, and operation 490 of storing a result image.

Specifically, when a selection on a depth image frame to be edited and a color image corresponding to the depth image frame is received from a user in operation 410, a selection on an interest object in the color image may be received in operation 430.

In operation 430, the selection on the interest object in the color image may be received using various schemes. For example, the various schemes may include a scheme of roughly drawing, by the user, an outline of the interest object, a scheme of drawing a square including the interest object, a scheme of indicating, by the user, an inside of the interest object using a straight line, a curved line, and the like, a scheme of indicating, by the user, an outside of the object, and the like.

Here, the color image may include a motion picture and a still image.

In operation 450, boundary information of the selected interest object may be extracted. In operation 450, the boundary information of the interest object may be extracted using, for example, a mean shift scheme, a graph cut scheme, a GrabCut scheme, and the like. Boundary information of an object may indicate a boundary of the object and thus, may include, for example, a coordinate value of a boundary point, a gray image, a mask, and the like.

Depending on embodiments, operation 430 and operation 450 may be simultaneously performed. For example, when the user drags a mouse, it is possible to find similar areas around a dragged area and thereby expand the areas. In addition, a scheme of expanding an inside of the object, a scheme of expanding an outside of the object, a scheme of combining the above two schemes, and the like may be applied.

In operation 470, a depth value of the depth image frame may be corrected using boundary information of the interest object extracted from the color image, and thereby the depth image may be corrected.

The most basic scheme of correcting the depth image in operation 470 may include a scheme of indicating, in the depth image, boundary information of the interest object obtained from the color image and then, directly editing, by an editor, the depth image using the indicated boundary information.

The depth image may be edited using a paint brush function that is generally used in, for example, Photo Shop, Paint Shop Pro, and the like.

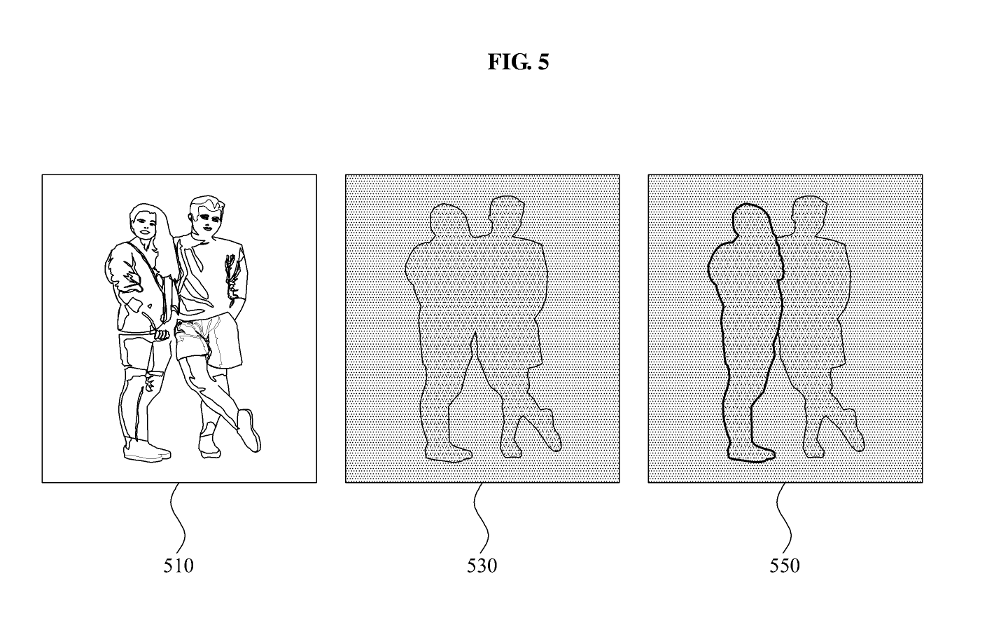

Prior to describing the scheme of correcting the depth image, a scheme of indicating, in the depth image, boundary information of the object obtained from the color image will be described with reference to FIG. 5.

FIG. 5 illustrates a 3D image including a color image 510 and a depth image 530, and an image 550 of indicating, in the depth image 530, boundary information of an object extracted from the color image 510 according to an embodiment of the present invention.

Referring to FIG. 5, it can be seen that the depth image 530 frame corresponding to a male of the color image 510 is inaccurate in a boundary portion of a corresponding object. In particular, a gate portion having a similar color to a head portion of the male has an inaccurate value. When indicating, in the depth image frame 530, boundary information of an interest object obtained from the color image 510, it can be more clearly seen.

Referring to the depth image frame 530, it can be seen that a depth value difference between the boundary area of the interest object and a background is significantly great. It may indicate that boundary information may be easily detected in the depth image.

Accordingly, when detecting, in the depth image frame 530, boundary information of the area corresponding to the interest object and comparing the detected boundary information with boundary information of the interest object obtained from the color image 510, it is possible to identify an area having a wrong depth value in the depth image frame.

Specifically, the depth value of the depth image frame 530 may be corrected by finding the area having the wrong depth value using the above scheme. The depth value of the depth image frame 530 may be automatically corrected or edited using an extrapolation scheme and the like.

When initially executing the aforementioned automatic edition prior to a manual depth image edition of the editor, it is possible to significantly decrease an amount of work used for the editor's depth image edition.

When the edition of the depth image frame 530 is completed, the result image edited in operation 490 may be stored. Operations 410 through 470 may be performed with respect to a plurality of frames depending on a necessity of the editor.

The result image may be stored every time the edition with respect to each frame is completed, or may be stored once when the edition with respect to all the frames is completed. Depending on embodiments, the result image may be stored while a process with respect to the plurality of frames is ongoing.

A basic flow of the within-frame depth image editing method according to an embodiment of the present invention is described above.

A predetermined image may not be corrected at a one time according to the aforementioned basic flow. For example, there may be an image from which boundary information of an interest object may not be easily extracted. In addition, there may be an image from which a satisfactory edition result may not be obtained using the aforementioned automatic edition.

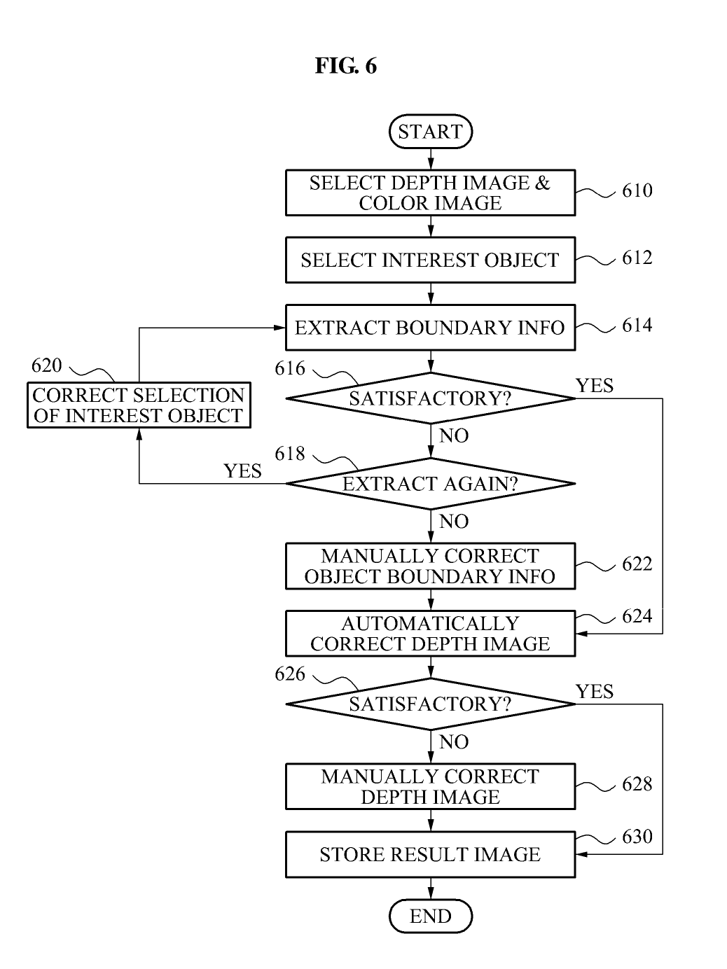

Accordingly, there is a desire for a method that may obtain a satisfactory result during a process of extracting boundary information of the interest object or editing the depth image, which will be described with reference to FIG. 6.

FIG. 6 is a flowchart illustrating a method of editing a depth image according to an embodiment of the present invention.

Referring to a boundary information extraction process of an interest object, when the interest object is selected according to an input of a user and boundary information of the selected interest object is unsatisfactory, it may be possible to more accurately extract the boundary information of the interest object using two schemes.

A first scheme may extract more accurate boundary information of the interest object by correcting an input of the user for selecting the interest object in operation 620 and thereby extracting again the boundary information of the interest object.

Specifically, when the boundary information of the interest objet extracted in operation 614 is unsatisfactory in operation 616, the selection on the interest object may be received again from the user in operation 618. Boundary information of the reselected interest object may be extracted in operation 614. A depth value may be corrected based on the boundary information of the reselected interest object in operation 624.

The first scheme may be usefully applied when an object boundary to be extracted is significantly different from the actual object and thereby an amount of work to be directly corrected by the user is determined to be significantly great.

A second scheme enables the user to directly correct the depth value in operation 622. The second scheme may be usefully applied when the extracted object boundary is generally satisfactory and a correction is required for only a particular portion. Both the first scheme and the second scheme may be combined and thereby be used.

While correcting the depth image frame, it may be possible to selectively perform the aforementioned automatic correction process and the manual correction process.

Specifically, whether to perform the automatic correction process in operation 624 or whether to perform only the manual correction process in operation 628 without performing the automatic correction process may be determined depending on the user's selection. When the automatic correction process is determined to be performed, whether to perform the manual correction process may be determined depending on whether the user is satisfied with the corresponding result in operation 626.

In operation 630, a result image generated through the automatic correction operation 624 or the manual correction operation 628 depending on the user's selection may be stored in a memory and the like.

Operations 610 through 614 and operation 624 of FIG. 6 are the same as operations 410 through 470 and thus, further detailed descriptions will be omitted here.

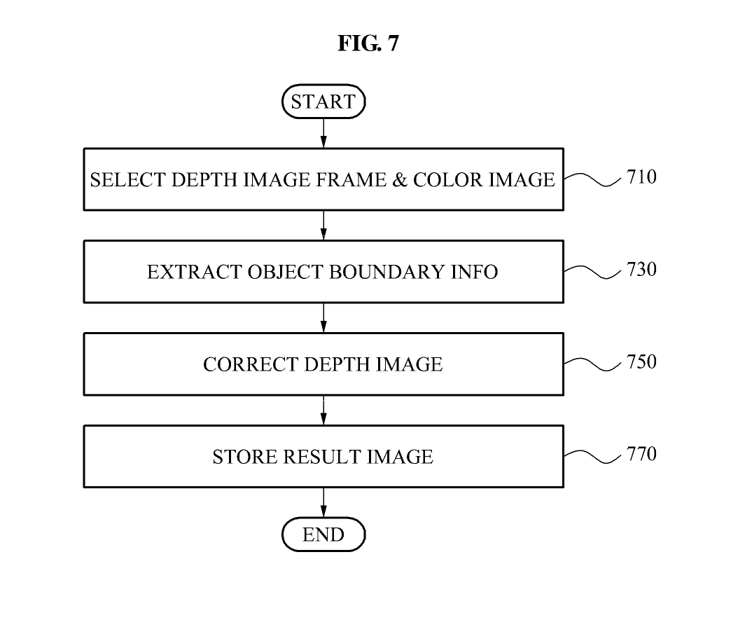

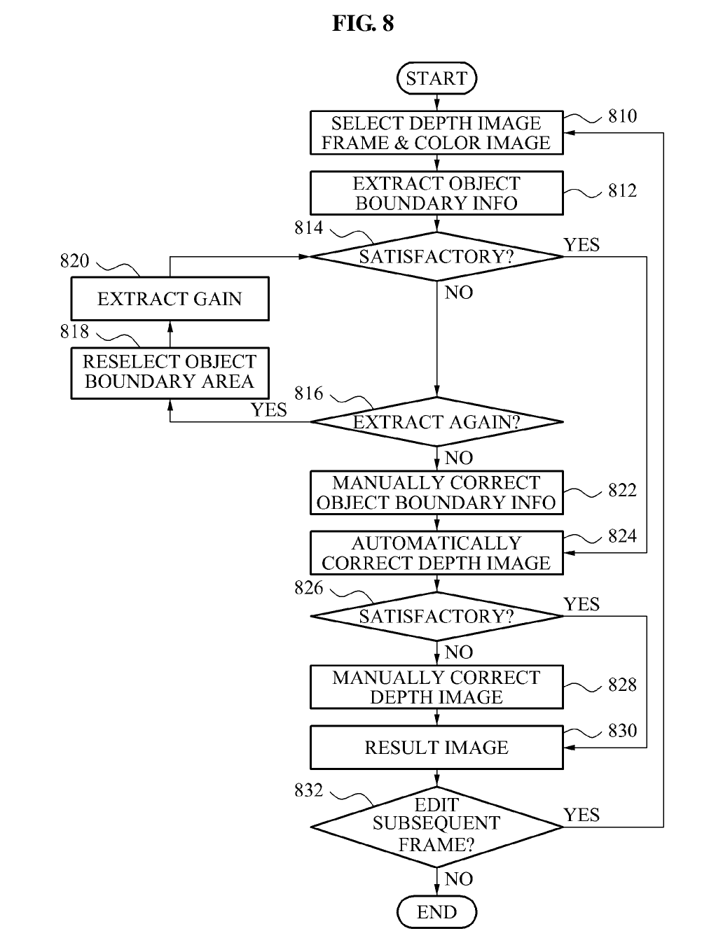

Depending on embodiments, a depth image editing method may use an inter-frame depth image editing method that may edit a depth value of a depth image of a current frame using information associated with a frame of a previous viewpoint or an adjacent frame of a color image. It will be further described with reference to FIG. 7 and FIG. 8.

In the inter-frame depth image editing method, a depth image frame that is an edition target and a color image corresponding to the depth image frame may have a great correlation between frames and thus, the correlation may be used for editing the depth image.

The inter-frame depth image editing method uses a similarity between frames and thus, may automatically edit the depth image without an intervention of the user. However, it is only an example and thus, the inter-frame depth image editing method may expand a function so that an editor may intervene and thereby perform a manual operation. It will be further described with reference to FIG. 8.

FIG. 7 is a flowchart illustrating a method of editing a depth image according to an embodiment of the present invention.

Referring to FIG. 7, the depth image editing method may include operation 710 of selecting a depth image frame and a color image, operation 730 of extracting object boundary information, operation 750 of correcting a depth image, and operation 770 of storing a result image.

In operation 710, a selection on a depth image frame to be edited and a color image corresponding to the depth image frame may be received from a user.

In operation 730, object boundary information of a current frame corresponding to the depth image frame may be extracted using a frame of a previous viewpoint or an adjacent viewpoint of the color image.

Also, in operation 730, object boundary information of the current frame may be extracted by tracing the frame of the previous viewpoint or the adjacent viewpoint of the color image according to a motion estimation scheme and the like.

Here, the motion estimation scheme used for extracting object boundary information of the current frame from the object boundary information of the frame of the previous viewpoint or the adjacent viewpoint of the color image may include a block matching algorithm (BMA), an optical flow, and the like.

In operation 750, the depth image may be corrected by correcting a depth value of the depth image frame based on object boundary information of the current frame.

Also, in operation 750, to correct the depth value of the depth image frame, an object boundary area to be corrected may be determined based on the object boundary information of the current frame and the depth value of the depth image frame may be corrected by applying an extrapolation scheme to the determined object boundary area.

A scheme described in the within-frame depth image editing method of the present invention may be applicable as is to the depth image correcting scheme using the extracted boundary. A depth value of a previous frame may be applicable.

When using the depth value of the previous frame, it is possible to correct the depth value by applying a depth value of a corresponding location in the previous frame with respect to an area needing a motion depth value correction, using a motion from the previous frame found during the object boundary extraction process.

Specifically, it is possible to determine the object boundary area to be corrected based on the object boundary information of the current frame, and to correct the depth value of the depth image corresponding to the determined object boundary area using the depth value of the corresponding location in the frame of the previous viewpoint or the adjacent viewpoint.

The aforementioned operations 710 through 750 may be automatically performed with respect to a plurality of frames depending on a necessity of the editor. Specifically, the aforementioned process may be automatically performed up to a last frame, or may be repeated as many times as a number of frames input by the user, or may be suspended during an operation as necessary.

In operation 770, a result image in which the depth image is edited may be stored. In this instance, the result image may be stored every time the edition with respect to each frame is completed, or may be stored once when the edition with respect to all the frames is completed. Depending on embodiments, the result image may be stored while a process with respect to the plurality of frames is ongoing.

The basic inter-frame depth image editing method is described above. As described above, even though the inter-frame depth image editing method is automatically performed, each automatic performance process may be unsatisfactory. In this case, a function of enabling the editor to automatically correct the depth value may need to be provided.

The expanded concept of the inter-frame depth image editing method including the above function will be described with reference to FIG. 8.

FIG. 8 is a flowchart illustrating a method of editing a depth image according to an embodiment of the present invention.

Referring to FIG. 8, the expanded inter-frame depth image editing method may suspend an automatic process when an editor determines that object boundary information of a current frame extracted using object boundary information of a previous frame is unsatisfactory in operations 814 and 816. Depending on a selection of an editor, an object boundary area may be extracted again in operation 820 by correcting the object boundary area in operation 818, or may be manually corrected in operation 822.

Specifically, in operation 818, a reselection selection on an object boundary area from which object boundary information of a current frame is to be extracted may be received from a user. A depth value of the depth image frame may be corrected by re-extracting the object boundary information from the object boundary area in operation 820.

The above process may be similar to a process performed in the aforementioned within-frame depth image editing method. Also, when the automatic correction result of the depth image is unsatisfactory in operation 826, a function of enabling the editor to manually correct the depth image in operation 828 may be included. Also, when the automatic correction result of the depth image is unsatisfactory in operation 826, a result image may be stored in operation 830 after the editor may manually correct the depth image in operation 828.

Operations 810, 820 and 824 of FIG. 8 may be the same as operations 710 through 750 of FIG. 7 and thus, further detailed descriptions will be omitted here.

When there is a need to edit a new color image frame or a subsequent color image frame, a process of selecting the depth image and the color image frame and following operations may be repeated by returning to operation 810. When there is no need to the color image frame, a depth image frame may be terminated in operation 832.

According to embodiments of the present invention, a depth image editing method may selectively use a within-frame editing method or an inter-frame editing method, or may use a combined method of the above two methods.

According to embodiments of the present invention, it is possible to use a within-frame depth image editing method with respect to all the frames, or to use the within-frame depth image editing method with respect to a first frame of the frames, and to use an inter-frame depth image editing method with respect to frames followed by the first frame.

As necessary depending on a decision of an editor, only the within-frame depth image editing method may be used and otherwise, the inter-frame depth image editing method may be used.

In describing the depth image editing method and apparatus described above with respect to FIG. 3 through FIG. 8, descriptions related to like constituent elements, terms, and other portions may refer to each other.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of editing a depth image, comprising:
receiving a selection on a depth image frame to be edited and a color image corresponding to the depth image frame;
receiving a selection on an interest object in the color image;
extracting boundary information of the interest object; and
correcting a depth value of the depth image frame using the boundary information of the interest object.

2. The method of claim 1, wherein:
the correcting comprises extracting, from the depth image frame, boundary information of an area corresponding to the interest object, and
the depth value of the depth image frame is corrected by comparing the boundary information of the area corresponding to the interest object with the boundary information of the interest object.

3. The method of claim 2, wherein the depth value of the depth image frame is corrected using an extrapolation scheme.

4. The method of claim 1, further comprising:
receiving a reselection on the interest object; and
extracting boundary information of the reselected interest object,
wherein the depth value is corrected using the boundary information of the reselected interest object.

5. A method of editing a depth image, comprising:
receiving a selection on a depth image frame to be edited and a color image corresponding to the depth image frame;
extracting object boundary information of a current frame corresponding to the depth image frame using a frame of a previous viewpoint or an adjacent viewpoint of the color image; and
correcting a depth value of the depth image frame using the object boundary information of the current frame.

6. The method of claim 5, wherein the extracting comprises extracting the object boundary information of the current frame by tracing the frame of the previous viewpoint or the adjacent viewpoint of the color image using a motion estimation scheme.

7. The method of claim 5, wherein the correcting comprises determining an object boundary area to be corrected based on the object boundary information of the current frame, and correcting the depth value of the depth image frame by applying an extrapolation scheme to the determined object boundary area.

8. The method of claim 5, wherein the correcting comprises determining an object boundary area to be corrected based on the object boundary information of the current frame, and correcting a depth value of a depth image corresponding to the determined object boundary area using a depth value of a corresponding location in the frame of the previous viewpoint or the adjacent viewpoint of the color image.

9. The method of claim 5, further comprising:
receiving a selection on an object boundary area from which the object boundary information of the current frame is to be extracted; and
re-extracting the object boundary information from the object boundary area,
wherein the depth value of the depth image frame is corrected using the re-extracted object boundary information.

10. An apparatus for editing a depth image, comprising:
an input unit to receive a selection on a depth image frame to be edited, a color image corresponding to the depth image frame, and an interest object in the color image;
an extraction unit to extract boundary information of the interest object; and
an edition unit to correct a depth value of the depth image frame using the boundary information of the interest object.

11. The apparatus of claim 10, wherein:
the edition unit comprises:
a boundary information extraction unit to extract, from the depth image frame, boundary information of an area corresponding to the interest object, and
the edition unit corrects the depth value of the depth image frame by comparing the boundary information of the area corresponding to the interest object with the boundary information of the interest object.

12. The apparatus of claim 11, wherein the edition unit corrects the depth value of the depth image frame using an extrapolation scheme.

13. An apparatus for editing a depth image, comprising:
an input unit to receive a selection on a depth image frame to be edited and a color image corresponding to the depth image frame;
an extraction unit to extract object boundary information of a current frame corresponding to the depth image frame using a frame of a previous viewpoint or an adjacent viewpoint of the color image; and
an edition unit to correct a depth value of the depth image frame using the object boundary information of the current frame.

14. The apparatus of claim 13, wherein the extraction unit extracts the object boundary information of the current frame by tracing the frame of the previous viewpoint or the adjacent viewpoint of the color image using a motion estimation scheme.

15. The apparatus of claim 13, wherein the edition unit determines an object boundary area to be corrected based on the object boundary information of the current frame, and corrects the depth value of the depth image frame by applying an extrapolation scheme to the determined object boundary area.

16. The apparatus of claim 13, wherein the edition unit determines an object boundary area to be corrected based on the object boundary information of the current frame, and corrects a depth value of a depth image corresponding to the determined object boundary area using a depth value of a corresponding location in the frame of the previous viewpoint or the adjacent viewpoint of the color image.
